(19) United States
(12) Patent Application Publication
(10) Pub. No.: US 2012/0287689 A1
(43) Pub. Date: Nov. 15, 2012

(54) SYNCHRONOUS RECTIFIER DISABLING ARRANGEMENT

(76) Inventors: William Vincent Fitzgerald, Zionsville, IN (US); William John Testin, Indianapolis, IN (US)

(21) Appl. No.: 13/518,945

(22) PCT Filed: Dec. 28, 2009
(86) PCT No.: PCT/US09/06718

§ 371 Date: Jun. 25, 2012

(51) Int. Cl. H02M 7/04; H02M 7/217; H02M 7/06

(52) U.S. Cl. 363/126; 363/125; 363/127

(57) ABSTRACT

A power supply receives an alternating current input that is rectified by a rectifier. The rectified output voltage is coupled to a load and a microprocessor during both a run mode operation and a standby mode operation. The rectifier provides synchronous rectification by an included MOSFET, during the run mode operation and non-synchronous rectification during the standby mode operation by an included Schottky diode. The Schottky diode in rectifier is in parallel with the MOSFET and provides rectification during the standby mode operation. A source of an on/off control signal from the microprocessor is applied to the load for changing the operation mode and applied, in parallel, to the rectifier for disabling the synchronous rectification in the rectifier, during the standby mode operation. The efficiency of the power supply is improved in the standby mode operation by elimination of the power consumed to energize a synchronous rectifier controller. The efficiency of the power supply is also improved in the standby mode operation by using the on/off control signal from the microprocessor to disable the synchronous operation.

### FIELD OF THE INVENTION

The present invention relates to power supplies utilizing synchronous rectification.

### BACKGROUND OF THE INVENTION

As shown in prior art FIG. 1, a power supply 100 of an electronic device 111 includes input side components 110 and secondary side components 120. Input side, also referred to as “hot side” components comprise an input bridge 112 to rectify an alternating current (AC) input supply 102 and switched mode circuitry to drive and regulate a primary winding 114 voltage. The power supply primary is referenced to a potential 116, also known as hot-side or non-isolated ground.

The secondary side 120 of the illustrative power supply 100 includes a power supply transformer secondary winding 124, with the primary 110 and the secondary 120 of the power supply 100 being separated by an isolation barrier 122 between the windings 114 and 124. The winding 124 is connected at a first end to a rectifier 230, which is referenced at its other terminal to a “cold-side” or isolated ground 128. The rectifier 230 comprises a synchronous rectifier 233 which comprises a Metal Oxide Semiconductor Field Effect Transistor (MOSFET) 234 connected in parallel with a rectifier diode 232. The rectifier diode 232 has its cathode connected to the MOSFET 234 drain and its anode connected to the ground 128. The MOSFET 234 includes a body diode 235, poled corresponding to the diode 232. A power supply output voltage 132 is developed at a second end of winding 124, where it is filtered by an electrolytic capacitor 130 and supplies an output load current 134 to a power supply load 295. Interposed between the power supply 100 and the load 295 is a load sensor 290. The load sensor 290 has as an output 202 a signal to disable synchronous rectification, selectively, in accordance with the load.

In many supplies, rectifier 230 may be placed with the opposite polarity on the second end of the winding 124 with the first end of winding 124 connected directly to the ground 128. An advantage of configuring the rectifier as shown in FIG. 1 is to facilitate heat sinking of the rectifier 230. The power supply primary may be configured as any number of well known power supply types, for example a clamped mode forward converter or a flyback converter. Although it is not essential that the power supply be of a switch-mode configuration, the need for efficiency usually favors that mode.

In the type of rectifiers described in this exemplary switch-mode supply, the diode 232 is often a Schottly diode due to an often large source of inefficiency; the voltage drop across a conventional rectifier diode. In higher power power supplies, the inefficiency introduced by the voltage drop across the diode can be significant, thus requiring heat sinking and possibly active measures such as forced air cooling. In order to meet the ever-increasing demand for high speed and miniaturization of digital devices, microelectronic circuit voltage levels have been dropping. Although 5 Volt and 12 Volt power supplies are still predominant, 3.3 Volt, 2.5 Volt, 1.8 Volt, and 1.5 Volt and others are becoming increasingly common as the standard voltages in many electronic devices. Previous designs using conventional rectifier diodes to rectify secondary AC voltage to a DC voltage, allow the output current on the secondary side to “freewheel” during the time that the power switches on the primary side are off. As requirements to minimize power consumed by electronic devices become more stringent and as operating voltages used in modern devices become lower, the power loss incurred in the rectifier diodes becomes very large compared to the output power. For example, using 0.5 V Schottky diodes in a 1V output power supply results in a power loss of approximately 33% of the output power in the rectifier circuit.

In order to improve the rectifier efficiency, a transistor, usually a Field Effect Transistor (FET) or more specifically a MOSFET can be used as a low voltage-drop switch to replace a diode. This technique is referred to as synchronous rectification. Synchronous rectification requires control of the drive to the synchronous rectifier to turn the MOSFET on during the lowest portions of the voltage being rectified and to turn the MOSFET off during the highest portions of the voltage being rectified. Integrated circuit controllers such as the ST Microelectronics STS-R3 or Anachip AP436 as well as discrete circuit designs are used to control conduction of the synchronous rectifier.

Further, high-power density is crucial in applications where the space for the power supply relative to the power output is limited. Thus, there is an ongoing quest to develop power supplies with increased efficiency, in part to minimize the need for or size of heat sinks. In addition, due to Energy Star and European CoC requirements, new power supply designs must maintain a high efficiency even at low output power levels and must have greatly reduced input power when small or no load is present. A synchronous rectifier can improve the efficiency of a power supply at normal and high load levels by reducing the conduction losses typical of a standard diode rectifier. The advantage of the synchronous rectifier FET is the very low “on resistance” of current FETs. Although synchronous rectifiers are much more efficient than diode rectifiers at today's lower voltage levels, they are not without their drawbacks. There is a certain amount of power overhead, most notably the power required to operate the synchronous rectifier controller that exists in driving the synchronous rectifier that can affect the efficiency of the power supply when a low output power level exists.

In the arrangement of FIG. 1, the output current or output power is sensed to disable the synchronous rectifier 234 during instances of low power or current operation. Disabling the synchronous rectifier during instances of low current or power operation minimizes reverse current flow, thus improving the efficiency and heat management of the power supply. However, undesirably, additional power is consumed by the load sensor 290. It may be desirable to disable synchronous rectification without using load sensor 290 that, disadvantageously, consumes power and complicates the circuitry.

### SUMMARY OF THE INVENTION

A disclosed embodiment of the invention relates to a power supply, which includes a source of an alternating current input supply and a rectifier that is coupled to a load for rectifying the input supply. A rectified output supply current is produced, during both a run mode operation and a standby mode operation, in a current path that is coupled to the load. The rectifier provides synchronous rectification, during the run mode operation. A source of an on/off control signal is applied to the load for reducing the rectified output supply current and is also applied, in parallel, to the rectifier for selectively disabling the synchronous rectification in the rectifier.

### BRIEF DESCRIPTION OF THE DRAWINGS

In the drawings:

FIG. 1 is a partially schematic, partially block diagram of known power supply practice;

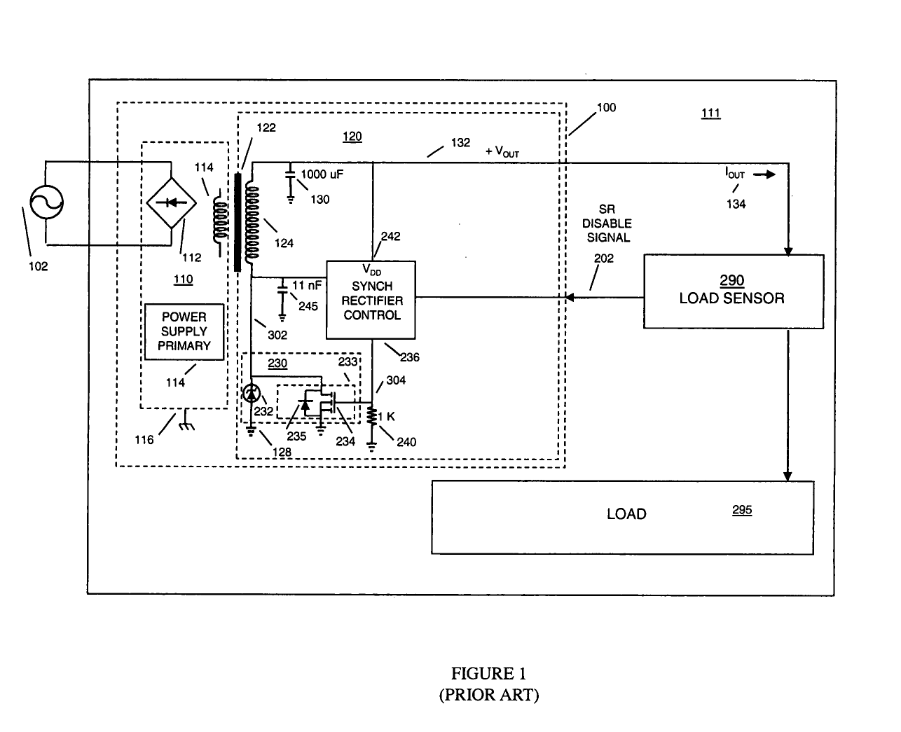

FIG. 2 is a depiction, partially in block diagram form and partly in schematic form of an electronic device incorporating an embodiment of the present invention;

FIG. 3 shows relevant waveforms at terminals of the rectifier of FIG. 2;

FIG. 4 is a schematic detailing the discrete circuitry of a synchronous rectifier controller; and

FIG. 5 shows relevant waveforms of the schematic of FIG. 4.

### DETAILED DESCRIPTION OF THE PREFERRED EMBODIMENT

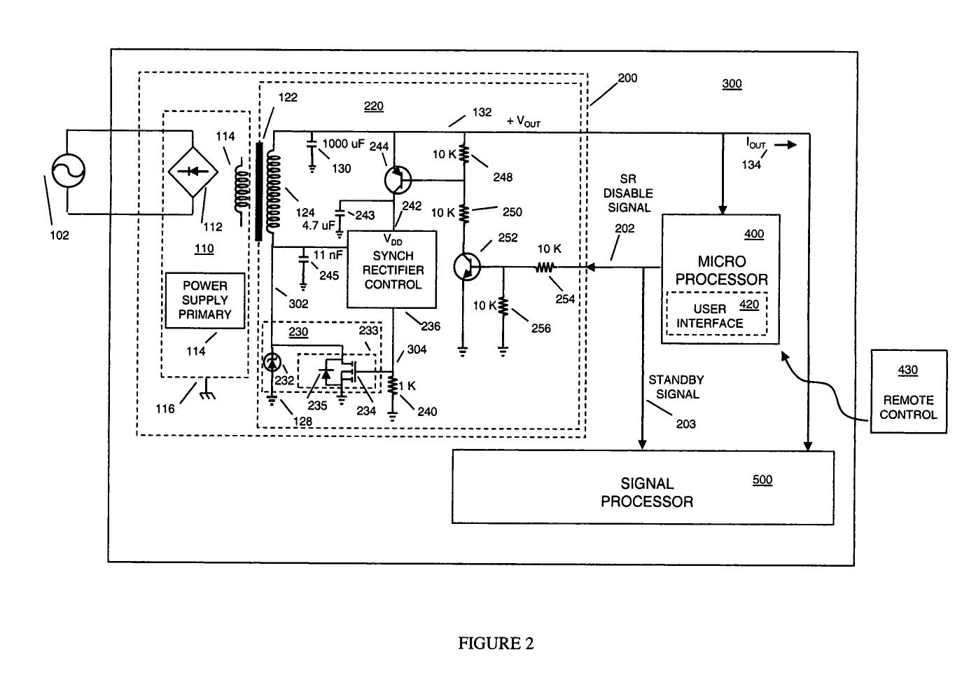

FIG. 2 depicts an electronic device, or more specifically a set top box 300 comprising a power supply 200, a system controller or microprocessor 400 and a signal processor 500. Parts of the power supply 200 contain components similar in function to components previously described regarding the power supply 100. In such instances these components will have common reference indicia as previously presented. The power supply 200 receives the AC input 102 and contains the power supply primary 110 and a power supply secondary 220. The primary 110 and the secondary 220 are connected inductively from the transformer primary winding 114 to the transformer secondary winding 124, and are isolated by the isolation barrier 122. The secondary winding 124 is connected, at a first terminal, to a first major current conduction terminal of the rectifier 230 and at a second terminal to produce the rectified output 132 (+V_{OUT}), 12 volts in the preferred embodiment. The output 132 is filtered by the filter capacitor 130 to produce the rectified output supply current 134 to power loads comprising operating circuits in the power supply secondary 220, the microprocessor 400 and the signal processor 500.

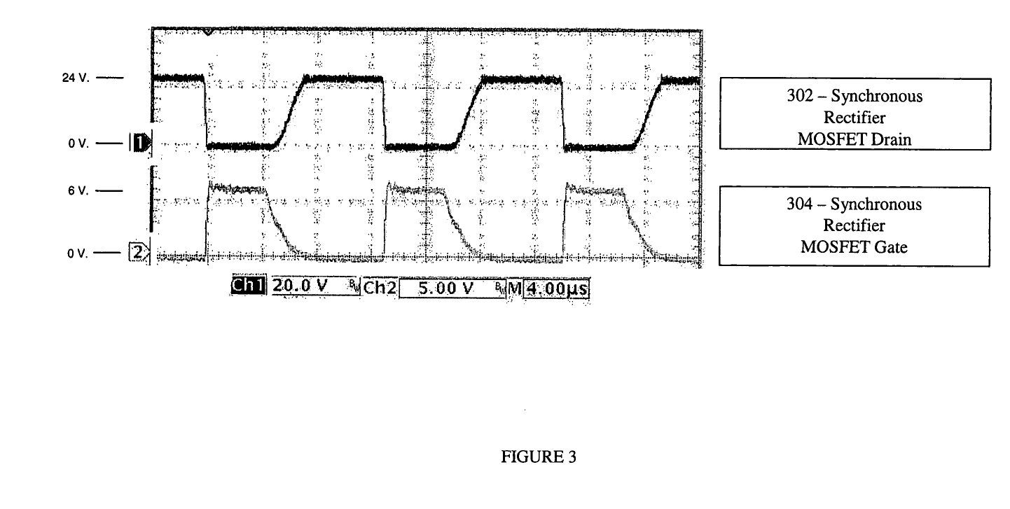

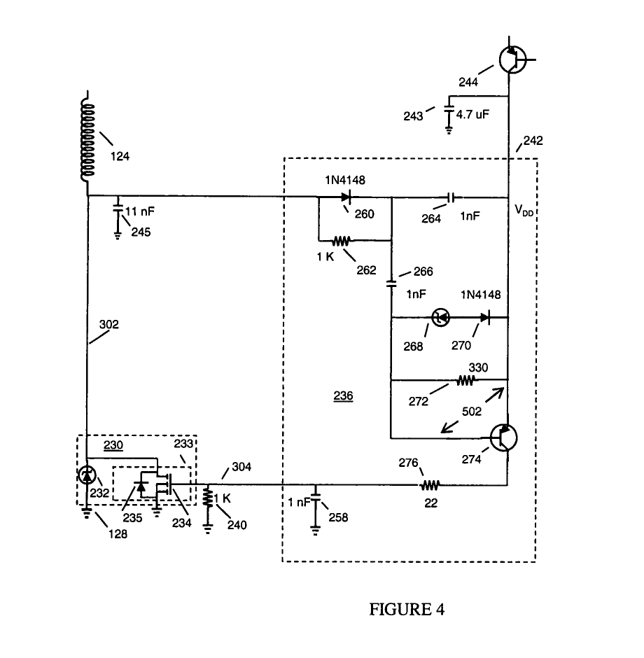

A second major current conduction terminal of the rectifier 230 is connected to the “cold” or isolated ground 128. A small value capacitor 245 is connected in parallel across the rectifier 230 to eliminate line conducted radiation caused by switching transients from the rectifier 230. The rectifier 230 also comprises a control terminal for determining conduction in a component, the synchronous rectifier 233, such as an STF6ON55F3 from ST Electronics, of the rectifier 230. The rectifier 230 also comprises the diode 232, in the embodiment of FIG. 2, a Schottky diode PDS835L by Diodes Inc. The synchronous rectifier 233 comprises the MOSFET 234 and the integral body diode 235. According to an embodiment of the present invention, the synchronous rectifier 233 is controlled to be conductive when the synchronous rectifier 234 drain is at its lowest excursion during periods of high power operation, also known as the “run mode”, of the power supply 200 by a control signal from a synchronous rectifier controller 236. In a preferred embodiment, the controller 236 is a discrete circuit design as will subsequently be described with reference to FIG. 4. Waveforms for controlling the synchronous rectifier 233 are shown in FIG. 3. A waveform 302 shows the voltage at the MOSFET 234 drain, with a waveform 304 as a voltage controlling the MOSFET 234 conduction. When the MOSFET 234 drain is at its lowest potential, the MOSFET 234 is turned on by the gate waveform 304 being positive. Conversely, the gate potential is reduced below a threshold voltage to inhibit conduction of the MOSFET 234 when the MOSFET 234 drain potential is at its highest potential. A resistor 240, connected from the MOSFET 234 gate to the ground 128, converts a current output of the controller 236 to the voltage drive waveform 304 and also provides a current path to ground to assure the MOSFET switches off when its drain goes positive.

In the embodiment of FIG. 2, under conditions of normal output power, that is between about 0.8 and 1.8 Amps, such as the “run mode” of the set top box 300, the synchronous rectifier controller 236 receives an operating voltage at a V_{DD} terminal 242 through a PNP switching transistor 244 part number MMBT589LT1G made by On Semi. The transistor 244 has an emitter connected to the output voltage 132 and a collector connected to the V_{DD} terminal 242 of the controller 236. The transistor 244 is, in turn, controlled by a 2N2222 NPN switching transistor 252, having an emitter connected to the ground 128. A collector of transistor 252 is connected through a voltage divider formed by a resistor 248 and a resistor 250 to a base of transistor 244. The base of transistor 252 receives its input from a synchronous rectifier disable signal 202 through a voltage divider formed by a resistor 254 and a resistor 256. When the disable signal 202 is in a high state, usually about 5 volts, the voltage divider 254, 256 powers the transistor 252 on. When the transistor 252 is turned on, its collector approaches ground potential, which, in turn through the divider 248, 250, turns the transistor 244 to its on state. With the transistor 244 turned on, its collector voltage approaches voltage +V_{OUT}, thus providing operating current to the controller 236. The controller 236 has a bypass capacitor 243 from the V_{DD} terminal 242 to ground to assure a low impedance operating supply to the controller 236 when the transistor 244 is conducting. An Output 304 of the controller 236, in this instance, produces the waveform that switches the synchronous rectifier 233 to its on state.

The microprocessor 400 is used to control the operations of the set top box 300. Through a microprocessor user interface 420 and often with the convenience of a remote control 430, the microprocessor 400 directs the operation of the signal processor 500 to, for example, select channels, play/record and turn on/off. In modern set top boxes, the command to turn off, signals the processor 500 to stop processing viewable activities and to enter a low power or “standby mode”. This partially powered state of less than 100 mA accommodates routine software downloads and also keeps the microprocessor user interface and the remote control interface active to receive and process a subsequent on command. For many reasons, it is important that the power consumed when a device is in such a standby state be kept as low as possible. When the microprocessor 400 signals the processor 500 to enter a standby or low current mode by a standby signal 203, the microprocessor, in parallel, sets the synchronous rectifier disable signal 202 to a low voltage state to turn the controller 236 off. When the disable signal 202 is in a low voltage state, the transistor 252 is turned off, which in response turns the transistor 244 off. When the transistor 244 is in its off mode, the waveform 304 is interrupted from the synchronous rectifier gate, thus turning off operation of the MOSFET 234. When the MOSFET 234 is made inoperative, the diode 232 of rectifier 230 provides rectification of the output voltage 132, thus still providing output voltage +V_{OUT}. The diode 232 may have a slightly larger voltage drop when it is conducting than the MOSFET 234 does when it is conducting, at low power output from the power supply 200. However, the reduction in efficiency of the power supply is minimal. With supply current to the controller 236 interrupted by the disable signal 202, the power supply 200 efficiency is significantly improved. It is possible that the diode 232 can be eliminated from the rectifier 230, with standby mode rectification being provided by the MOSFET body diode 235.

Although the disable signal 202 and the standby signal 203 are shown in FIG. 2 as directly connected to each other, they could be two separate but parallel signal paths from the microprocessor 400. One reason for separate but parallel signal paths can be an instance where different polarities are required for the signals 202 and 203. It should also be considered that either or both of the signals 202 and 203 can be communicated by bit patterns in a serial communications bus such as an IIC bus.

FIG. 4 describes a schematic of the synchronous rectifier controller 236 of the presently preferred embodiment. The signal 302 is applied to the anode of a diode 260 and to one terminal of a resistor 262. The cathode of diode 260 is connected a second terminal of the resistor 262, a common connection of which is connected to a first terminal of a capacitor 264. A second terminal of the capacitor 264 is connected to the V_{DD} terminal 242 of the controller 236. The combination of the diode 260, the resistor 262 and the capacitor 264 forms a fast attack, slow decay filtered signal at a first terminal of capacitor 264. When the signal 302 goes positive, the capacitor 264 is charged quickly. When the signal 302 goes in a negative direction, the diode 260 is reverse biased and the signal at the first terminal of the capacitor 264 decays in a negative direction through the resistor 262 with a time constant of approximately the resistor 262 value times the capacitor 264 value.

A capacitor 266 is connected from the junction of the resistor 262, the diode 260 and the capacitor 264 to a base of a PNP transistor 274 part number MMBT589LT1G by On Semi. Also connected to the base terminal of transistor 274 is a resistor 272, which is connected between the base and emitter of transistor 274. A 4.7 Volt zener diode 268 BZT52C4V7 manufactured by Diodes, Inc. and a conventional diode 270 are connected in series with each other and also from the base to emitter of transistor 274. A cathode of Zener diode 268 is connected to the base of transistor 274 and a cathode of diode 270 is connected to the transistor 274 emitter, with the anodes of the two diodes connected together. The emitter of transistor 274 is returned to the V_{DD} 242 of the controller 236. The capacitor 266 and the resistor 272 form a differentiator to apply differentiated pulses to the base emitter junction of transistor 274. When the signal 302 goes in a negative direction, a moderately broad pulse from the differentiator causes the transistor 274 to conduct current from the V_{DD} 242 to the ground 128 through a load resistance formed by a resistor 276 in series with the resistor 240. The positive going voltage thus developed across the resistor 240 produces a positive portion of signal 304 applied to the gate of the MOSFET 234.

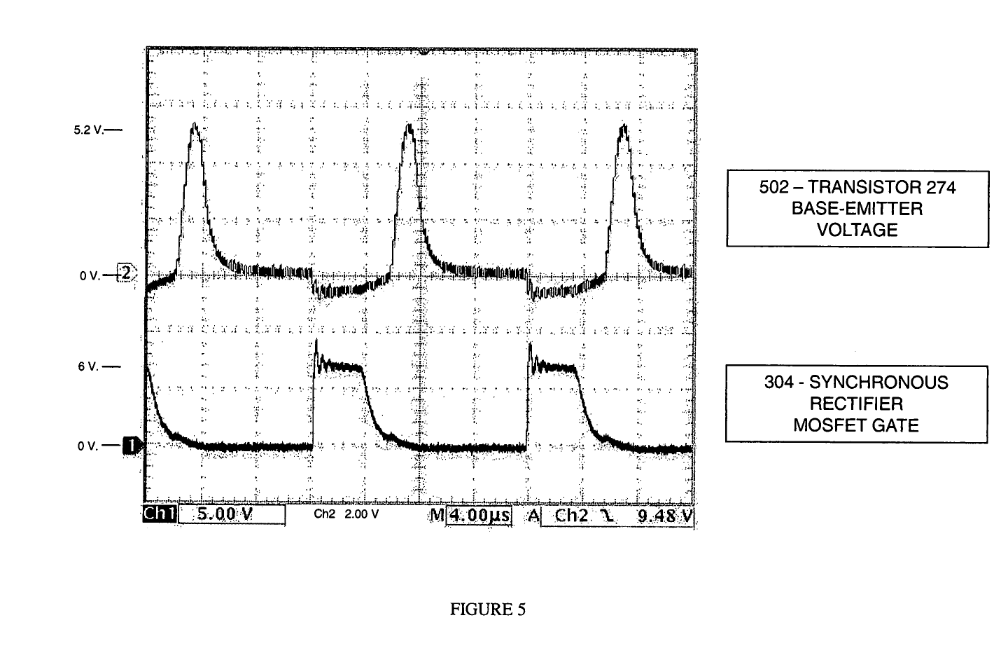

When the voltage 302 goes in a positive direction, the voltage developed across the capacitor 264 goes positive rapidly, which, in turn, is differentiated by the capacitor 266 and the resistor 272 to quickly render the transistor 274 non-conductive. When the transistor 274 ceases conduction, the voltage developed at the gate of the MOSFET 234 drops below a threshold of conduction of the MOSFET. A clipper formed by the diodes 268 and 270 allow a positive excursion of approximately 5.4 volts (Zener voltage plus one forward diode drop) of the base emitter voltage of the transistor 274 to assure that the base emitter of transistor 274 does not exceed its reverse breakdown voltage. The resistor 276 is placed in series between the transistor 274 collector and the MOSFET 234 gate to form, with a capacitor 258, a low pass filter to reduce radio frequency interference due to switching of the MOSFET 234. The waveforms in FIG. 5 show graphically the base to emitter voltage 502 of the driver transistor 274 with reference to the synchronous rectifier gate voltage 304.

In the present invention, the power supply is made more efficient under all conditions by avoiding the use of a supply current load sensor. Additionally, advantageously, under standby conditions the current supply to the controller 236 is interrupted. In addition the power supply can be smaller and more cost effective than those previous applications by elimination of the components and space required for a load sensor.

1. A power supply, comprising:
a source of an alternating current input supply;
a rectifier coupled to a load for rectifying said input supply to produce the rectified output supply current, during both a run mode operation and a standby mode operation, in a current path that is coupled to said load, said rectifier providing synchronous rectification, during said run mode operation; and
a source of an on/off control signal applied to said load for reducing said rectified output supply current and applied, in parallel, to said rectifier for selectively disabling the synchronous rectification in said rectifier.

2. The power supply according to claim 1, wherein the signal that is applied to said rectifier for disabling the synchronous rectification in said rectifier is substantially unaffected by the output supply current reduction.

3. The power supply according to claim 1, wherein said on/off control signal source comprises a microprocessor.

4. The power supply according to claim 1, wherein said on/off control signal source is responsive to a user power off command.

5. The power supply according to claim 1, wherein said rectifier comprises a diode for performing non-synchronous operation, during said standby mode operation, and a semiconductor switch coupled to said rectifier for enabling the synchronous operation, during said run mode operation, and wherein said semiconductor switch is responsive to said parallel applied on/off control signal for selectively disabling the synchronous rectification in said rectifier to change the mode of operation from said run mode operation to said standby mode operation.

6. The power supply according to claim 5, wherein said diode comprises a Schottky device.

7. The power supply according to claim 1, wherein said rectifier comprises a field effect transistor.

8. A system for controlling a power supply, comprising:
means for receiving an alternating current input;
means, coupled to a load, for rectifying said alternating current input to produce a rectified output supply current, during both a run mode operation and a standby mode operation, in a current path that is coupled to said load, said rectifying means providing synchronous rectification, during said run mode operation; and
means for providing an on/off control signal applied to said load for reducing said rectified output supply current and applied, in parallel, to said rectifying means for selectively disabling the synchronous rectification in said rectifying means.

9. The system according to claim 8, wherein the signal that is applied to said rectifying means for disabling the synchronous rectification in said rectifying means is substantially unaffected by the output supply current.

10. The system according to claim 8, wherein said means for providing said on/off control signal comprises a microprocessor.

11. The system according to claim 8, wherein means for providing said on/off control signal is responsive to a user power off command.

12. The system according to claim 8, wherein said rectifying means comprises a diode for performing non-synchronous operation, during said standby mode operation, and means for switching coupled to said rectifying means for enabling the synchronous operation, during said run mode operation, and wherein said switching means is responsive to said parallel applied on/off control signal for disabling the synchronous rectification in said rectifying means to change the mode of operation from said run mode operation to said standby mode operation.

13. The system according to claim 12, wherein said diode comprises a Schottky device.

14. The system according to claim 8, wherein said rectifying means comprises a field effect transistor.

15. A method for efficiency improvement of a power supply comprising the steps of:
receiving an input alternating current;
rectifying said input alternating current to produce a synchronously rectified output supply current, during a run mode operation of an electronic device and a non-synchronously rectified output supply current, during a standby mode operation of said electronic device, in a current path that is coupled to a load; and
generating an on/off control signal, applied to said load to switch said load to a standby mode operation and, applied in parallel, to said power supply to switch, selectively, said power supply to a non-synchronously rectified mode.

16. The method according to claim 15, further comprising the step of placing said power supply in said non-synchronous mode independently of the current supplied to said load.

17. The method according to claim 15, further comprising the step of generating said on/off control signal by a microprocessor.

18. The method according to claim 15, further comprising the step of generating said on/off control signal in response to a user power off command.

19. The method according to claim 15, further comprising the steps of synchronously rectifying said input alternating current with an FET device and non-synchronously rectifying said input alternating current with a diode.

20. The method according to claim 19, further comprising the step of non-synchronously rectifying said input alternating current with a Schottky diode.

21. A power supply, comprising:
a source of an alternating current input supply;
a rectifier coupled to a load for rectifying said input supply to produce a rectified output supply that is coupled to said load, during both a run mode operation and a second mode operation, said rectifier providing synchronous rectification, during said run mode operation; and
a source of an on/off control signal applied to said load for changing the operation mode and applied, in parallel, to said rectifier for selectively disabling the synchronous rectification in said rectifier, during said second mode operation.
